(19) United States
(12) Patent Application Publication
(10) Pub. No.: US 2012/0149264 A1
(43) Pub. Date: Jun. 14, 2012

(54) Composite Reinforcement for Roofing Membranes

(75) Inventors: John F. Porter, St. Catharines (CA); Richard J. Goupil, Williamsville, NY (US)

(73) Assignee: SAINT-GOBAIN ADFORS AMERICA, INC., Grand Island, NY (US)

(21) Appl. No.: 13/294,700

(22) Filed: Nov. 11, 2011

Related U.S. Application Data
(60) Provisional application No. 61/412,441, filed on Nov. 11, 2010.

(51) Int. Cl. B32B 5/26; C09J 5/04; C09J 5/00

(52) U.S. Cl. 442/35; 156/324; 156/280

(57) ABSTRACT

A reinforcement membrane for reinforcing a roofing membrane has first and second layers including a fiberglass mat and a scrim of low-shrinkage organic fibers; a third layer comprising nonwoven low-shrinkage organic fibers providing an added mass of the low-shrinkage organic fibers for possessing latent shrinkage while the reinforcement membrane is in tension, which latent shrinkage is released in the absence of tension thereon during a temperature increase within a range of about 10° C. to about 30° C.; and a membrane coating material bonds together the three layers in tension, without completely filling interstices among the respective fibers of the three layers, wherein the interstices are adapted to be filled with a bituminous roofing composition.

### CROSS REFERENCE TO RELATED APPLICATION

This application claims priority from U.S. Provisional patent application No. 61/412,441, filed Nov. 11, 2010, entitled “Composite Reinforcement for Roofing Membranes,” naming inventors John F. Porter and Richard J. Goupil, which application is incorporated by reference herein in its entirety.

### FIELD OF THE INVENTION

The invention relates to a reinforcement membrane for reinforcing a bituminous roofing membrane, a method of making the reinforcement membrane, and a roofing membrane having the reinforcement membrane.

### BACKGROUND

U.S. Pat. No. 5,695,373 discloses a reinforcement membrane for reinforcing a bituminous (asphaltic) roofing membrane. A process for making a unitary composite to use in reinforcing includes steps of selecting, as a first layer, an open, non-woven grid of low shrinkage, continuous filament polyester yarns that are at low tension, adhesively securing together the continuous filament yarns of the first layer using vulcanizable rubber binder while maintaining the non-woven grid open, selecting, as a second layer, a lightweight, preformed fiberglass mat and adhesively securing the first and second layers together using vulcanizable rubber binder to form a composite, such that at least some of the individual yarns of the first layer are at least partially coated and impregnated by the adhesive without forming a film that closes all openings through the composite. In an exemplary embodiment, the first layer is a laid scrim in which cross-machine direction yarns are laid between machine direction yarns at low tension. Specifically, it is preferred that the tension be maintained to achieve no more than 1.5% stretch of the polyester yarns during the scrim-making process. Notably, the composite when used in reinforcing membranes, has significantly reduced (virtually no) overall shrinkage as well as significantly reduced (virtually no) relative shrinkage of the first and second layers. In an exemplary embodiment, the low shrinkage polyester yarns have at most 3.0% shrinkage based on a hot air shrinkage (HAS) test at 350° F. for thirty minutes. It is more preferred that this shrinkage be at most 2.5% and most preferred that this shrinkage be at most 2.0%. It is preferred to secure together the continuous filament yarns of the first layer, and the first and second layers, using vulcanizable rubber binder, such as cross-linked styrene butadiene rubber, which preferably includes about 50% to about 80% styrene, and more preferably, about 65% to about 75% styrene, while around 70%, say on the order of 67%, is most preferred. The composite is flexible, capable of being impregnated by bituminous material and sufficiently strong to be useful in reinforcing an asphaltic roofing membrane comprised of the bituminous material and having the composite imbedded therein to reinforce the roofing membrane. However, while using the composite for manufacturing the asphaltic roofing membrane, the scrim of the composite is exposed and the elongated strands of the scrim are vulnerable to peeling and fouling the manufacturing equipment. Further, to eliminate curl of the roofing membrane due to shrinkage, the polyester material in the composite is low shrinkage polyester, and the volume or mass content of the polyester material is purposely low to minimize shrinkage caused by the polyester material.

Asphaltic roofing membranes are supplied in roll form, and are referred to as roll roofing membranes. In typical applications, such roofing membranes are installed by unrolling sheets of approximate dimensions: 1 meter wide and 10-15 meters long parallel to an edge or eve of a roof deck. The roll roofing membrane is rolled out over a waterproof roofing adhesive that adheres the roofing membrane to the roof deck. Installation of a roofing membrane according to a process referred to as a “hot-applied” process, utilizes a roofing adhesive of bitumen composition that is heated to an elevated temperature, well above ambient, and applied while hot to cover the roof deck. The roofing membrane is then rolled out over the hot bitumen roofing adhesive to form an immediate waterproof adhesive bond between the roof deck and the roofing membrane.

Recent improvements in polymeric adhesives form an adhesive bond at ambient temperatures, which advantageously permits installation of a roofing membrane according to a cold-applied process, described by Laaly, Dr. Heshmat O., Cold-applied BUR Emulsions and Coatings, Interface, November 2002. The cold-applied process utilizes a roofing adhesive applied at ambient temperatures. The roofing membrane is installed over the cold-applied adhesive, and is followed by a passage of time required for the cold-applied adhesive to set, first to an increased tacky state, and then to a fully cured state. Exposure to increasing ambient temperatures and sunlight is desirable for the adhesive to warm and fully set to a cured state, which forms a permanent waterproof adhesive bond between the roofing membrane and the roof deck. A drawback of the cold-applied process can result in an undesired thermal expansion of the roofing membrane shortly in time after being cold-applied.

A roofing membrane is made by permeating a fibrous reinforcement with a hot bituminous (asphaltic) roofing composition to provide a thickened membrane which is subsequently cooled and which contains the roofing membrane serving as a reinforcement of the thickened membrane. A reinforcement membrane can contain inorganic fiberglass for reinforcing a bituminous (asphaltic) roofing membrane. The fiberglass is thermally stable which is suitable for withstanding hot saturation by a bituminous roofing composition. The fiberglass has a low coefficient of thermal expansion (relative to that of the largely organic asphalt or modified bitumen saturant composition). During cooling of the reinforced membrane immediately after permeation, the bitumen saturant shrinks in three orthogonal dimensions faster than the largely inorganic reinforcement fibers. During the latter stages of cooling the bitumen shrinkage exerts compression on the inorganic reinforcement fibers especially in a longitudinal direction or machine direction of the membrane. This built-in compression of the reinforcement has consequences on a roof when the membrane is installed using cold-applied solvent-based adhesives, especially when the membrane is stored and installed while having a relatively low temperature (for example 10° C.). If the installed membrane heats up to, for example, 30° C. due to a diurnal ambient temperature increase, and with or without exposure to direct sunlight, the bitumen roofing membrane undergoes thermal expansion. This thermal expansion (of a 1 m×15 m roll of reinforced membrane) occurs primarily in the lengthwise machine direction (15 m direction) when measured in absolute terms. The roofing adhesive can take days to set up, and may be only slightly tacky for a period of time. This thermal expansion causes thermal distortion of the roofing membrane occurring at locations where adhesion to the roof deck is weakest. At such locations the thermal expansion can accumulate, and cause an undesired thermal distortion in the form of a raised ridge or an elongated raised hollow hump referred to as a “mole-run” for its similarity to tunneling in a lawn by a mole animal. When the roofing adhesive fully cures, the thermal distortion becomes irreversible.

The formation of a raised ridge or raised hollow hump could be overcome by cutting the asphaltic roofing membranes into pieces of short lengths before installing the pieces by a cold-applied process. The short lengths would eliminate accumulation of thermal expansion as the cause of undesired thermal distortion. However, cutting the roofing membranes to short lengths increases installation time, and requires added care to install the pieces while attempting to eliminate discontinuities at edges of the membrane pieces. It follows, a need exists for a reinforcement membrane for reinforcing a roofing membrane, wherein the reinforcement membrane serves to eliminate thermal distortion of the roofing membrane after being installed by a cold-applied process.

### SUMMARY OF THE INVENTION

The invention relates to a reinforcement membrane for reinforcing a roofing membrane of bituminous roofing composition, and a method of making the same. The reinforcement membrane includes first and second layers including a fiberglass mat and a scrim of low-shrinkage organic fibers, and a third layer comprising nonwoven low-shrinkage organic fibers, wherein the third layer covers and protects the scrim. The third layer provides an added mass of the low-shrinkage organic fibers for possessing latent shrinkage while the reinforcement membrane is in tension, which latent shrinkage is releasable to occur in the absence of tension thereon during a temperature increase within a range of about 10° C. to about 30° C. A membrane coating material bonds together the three layers, without completely filling interstices among the respective fibers of the three layers, wherein the interstices are adapted to be filled with a bituminous roofing composition for retaining the reinforcement membrane in tension.

A method of making a reinforcement membrane for reinforcing a roofing membrane is performed by adding a third layer comprising nonwoven or woven low thermal-shrinkage organic fibers to first and second layers including a fiberglass mat and a scrim of low-shrinkage organic fibers, wherein the third layer covers and protects the scrim, and the third layer provides an added mass of the low-shrinkage organic fibers for possessing latent shrinkage while the reinforcement membrane is in tension, which latent shrinkage is releasable to occur in the absence of tension thereon during a temperature increase within a range of about 10° C. to about 30° C.; and bonding together the three layers with a membrane coating material, without completely filling interstices among the respective fibers of the three layers, wherein the interstices are adapted to be filled with a bituminous roofing composition for retaining the reinforcement membrane in tension.

An embodiment of the invention includes a roofing membrane having a reinforcement membrane comprising first and second layers including a fiberglass mat and a scrim of low-shrinkage organic fibers, and a third layer comprising nonwoven low-shrinkage organic fibers, wherein the third layer covers and protects the scrim; the third layer providing an added mass of the low-shrinkage organic fibers for possessing latent shrinkage strain while the reinforcement membrane is in tension, which latent shrinkage strain is releasable to occur in the absence of tension thereon during a temperature increase within a range of about 10° C. to about 30° C.; a membrane coating material bonds together the three layers, without completely filling interstices among the respective fibers of the three layers; and a bituminous roofing composition filling the interstices and restraining the reinforcement membrane stretched and in tension.

### DETAILED DESCRIPTION

An embodiment of a reinforcement membrane includes an outer first layer of a mat of glass fibers held by a binder, a second layer of a scrim of organic fibers held by a binder and an outer third layer of nonwoven organic fibers held by a chemical binder, or by thermal heating and melt bonding or by mechanical connection, for example, connection by needling. The scrim has machine direction fibers extending lengthwise in the machine direction and cross-machine fibers extending in the cross-machine direction. The scrim is an interior layer to avoid unraveling or peeling of the fibers which would contaminate manufacturing machinery.

The reinforcement membrane is rolled up lengthwise and is shipped to a manufacturing site where the composite is unrolled and conveyed continuously lengthwise in a machine direction, while being stretched and in tension, while a hot, melted or molten bitumen roofing composition permeates the reinforcement membrane to fill interstices in the composite and forms a relatively thick roofing membrane. During manufacture of a roofing membrane, the reinforcement membrane is stretched in tension and is imbedded below the exterior surfaces of the roofing membrane to reinforce the roofing membrane. The resulting roofing membrane is quickly cooled to a temperature less than about 45° C. which locks the stretched composite in residual tension, wherein the composite possesses residual shrinkage strain. Then the roofing membrane is taken up by being wound into rolls of continuous length ready for installation on a roofing deck.

Prior to the invention, reinforcement membranes for reinforcing roofing membranes have focused on extreme dimensional stability over temperature changes. Virtually all prior reinforcement membranes are focused on the use of fiberglass fibers and the use of low-shrinkage polyester nonwoven fibers, wherein the polyester fibers are of minimum lengths to minimize dimensional changes with temperature, and wherein substantial amounts of fiberglass fibers possessing dimensional stability counteracts the presence of polyester fibers having dimensional instability. The purpose is to attain dimensional stability over changes in temperature. The dimensional stability is required while a hot, melted or molten bitumen roofing composition permeates the reinforcement membrane to fill interstices in the composite and forms a relatively thick roofing membrane. Dimensional instability would cause undesired variations in manufacturing the roofing membrane.

However, we have found that extreme dimensional stability is counter-productive to a need for eliminating the problems of thermal expansion of the finished roofing membrane under a changing diurnal changing environment as described herein. Supporting this conclusion is that heavy urea-formaldehyde bound fiberglass mats, which have excellent dimensional stability, still allow the cold-applied membrane to form vertical distortion defects. Our invention depends on reinforcement membranes having a pent up, stored or latent shrinkage form of dimensional instability. When the finished roofing membrane is cold-applied in the ambient air and sunlight, the roofing membrane is laid in the absence of tension thereof to cover and engage a layer of cold-applied adhesive on the roof deck, and the pent-up, stored or latent shrinkage in the polyester component will relax, which results in shrinkage forces to occur. These shrinkage forces counteract vertical distortion defects due to accumulations of thermal expansion of the roofing membrane, and which occur particularly in the machine direction of manufacture.

If there is only a single reinforcement membrane used, then the reinforcement membrane must be a composite having a combination of high-elongation and low-elongation fibers. The low elongation component is preferably a wet-laid or dry-laid fiberglass mat. The glass component(s) is(are) helpful in at least two ways. First, the glass component gives dimensional stability to the composite reinforcement as it is being immersed in a molten bitumen roofing composition, asphalt (or modified bitumen) at 175-200 ° C. Purely polyester reinforcements would stretch under tension in the machine direction and shrink in the cross-machine direction if not supported by the glass or other high temperature-resistant fiber. While the machine direction (longitudinal direction) must contain sufficient polyester fiber to induce the desired effect, it may not be necessary to have much if any polyester fiber oriented in the cross-machine or transverse direction. The polyester component serves, at a minimum, to retain latent shrinkage to offset the expansive forces of the asphalt or modified bitumen matrix during warming immediately after installation. In addition the polyester may serve to provide a substantial amount of bulk and the membrane's ultimate strength. When the polyester component is substantial it may also confer a high elongation-to-break to the finished membrane. At more modest levels, the 2nd function of primary strength member may be provided by one of the other substrates such as a fiberglass mesh.

Polyester-based reinforcements can behave differently in important ways, during roofing membrane production, and thereafter while on the roof after installation. During production the polyester expands to a greater degree than fiberglass and even to a greater degree than a matrix of highly-filled asphalt or modified bitumen roofing composition applied at an elevated melt temperature. It follows, a low-shrinkage polyester-based reinforcement is desired for the production line, which minimizes a wide range of dimensional changes due to shrinkage and expansion during production.

At the cooling location in the production line the polyester reinforcement builds up latent shrinkage strain greatly due to, both reversible shrinkage being retained, and irreversible shrinkage established at the highest temperatures in the production line. The irreversible shrinkage is due to latent shrinkage strain temporarily locked up in the cooled, solidified asphalt or bitumen matrix. The latent shrinkage strain is released to cause a net shrinkage in the machine direction during diurnal solar and ambient heating of the membrane shortly after application on the roof. The net shrinkage offsets the thermal growth or expansion of the asphalt or modified bitumen resulting in an absence of “ridges” or mole runs. It is possible that three important effects take place during (newly installed) membrane diurnal heating within a temperature range of about 10° C. to about 30 ° C.:

(a) The asphalt or modified bitumen matrix exhibits expansive forces and movement primarily in the long (machine) direction.

(b) The asphalt or modified bitumen weakens or becomes more fluid due to thermal softening.

(c) The polyester-based reinforcement shrinkage forces can be released due to increased mobility of the polymer backbone chain relaxing due to one of two thermal transitions and due to (b) above. The combined effect of (a, b, c) is that the matrix expansive forces are offset by the reinforcement's shrinkage force.

Accordingly, it is desirable to provide a polymer-based reinforcement membrane for possessing the desired polyester-based reinforcement shrinkage forces. The invention provides such a reinforcement membrane and a method of making the same, wherein a method of making a reinforcement membrane for reinforcing a roofing membrane includes adding a third layer comprising nonwoven low-shrinkage organic fibers to first and second layers including a fiberglass mat and a scrim of low-shrinkage organic fibers, especially those fibers in the scrim extending in the machine direction, wherein the third layer covers and protects the scrim, and the third layer provides an added mass of the low-shrinkage organic fibers, especially those fibers in the third layer extending in the machine direction, for possessing latent shrinkage while the reinforcement membrane is in tension, which latent shrinkage is releasable to occur during a temperature increase within a range of about 10° C. to about 30° C., and bonding together the three layers with a membrane coating material, without completely filling interstices among the respective fibers of the three layers, wherein the interstices are adapted to be filled with a bituminous roofing composition for retaining the reinforcement membrane in tension.

Our composite reinforcement has a fiberglass component strong enough to support the composite reinforcement as a carrier as it passes through a molten asphalt coating or a modified bitumen coating. Our composite reinforcement has an added polyester component to serve, by counteracting the glass and asphalt tendencies to grow in volume by thermal expansion, and especially in the longitudinal direction or machine direction.

The use of organic fibers, such as, polyester is not obvious in combination with asphalt coatings, as the ultimate elongation (elongation to break) of filled asphalt coatings is low, and on the order of 2%. Conventional wisdom would be to use only glass or other fibers of correspondingly low elongation to break. It would otherwise be considered inappropriate and wasteful to include a significant amount of high elongation-to-break fibers such as polyester. During a tensile test, the asphalt would rupture at 2-3% stretch, long before stretching would cause rupture of the polyester component of the reinforcement. By contrast, the ultimate elongation-to-break of polyester is roughly 16-45%. Polyester would therefore be considered incompatible or inappropriate from a design point of view to reinforce asphalt coatings.

There are other reasons why the use of polyester is not obvious as an element useful in solving this problem. Polyester material is known to expand according to its thermal coefficient of expansion in the temperature range 5-50° C. The unexpected observation in the invention, however, is that the low shrink polyester under tension in the reinforcement membrane appears to shrink in the absence of tension thereon when undergoing a temperature increase within a temperature range, for example, about 5° C. to about 50° C. This phenomenon may be due to built-in longitudinal stress and strain during the membrane coating process. The stress and strain may be locked into the reinforcement membrane during the cooling process (when the product is under tension in the machine direction during manufacture, and cools from, about 190° C. to about 35° C.). The locked in thermal expansion while at an elevated temperature, at about 190° C., in the composite or reinforcement membrane before bituminous coating permeates the composite or reinforcement membrane, may also play a role in shrinkage. Locked in, stored, or residual shrinkage and locked in thermal expansion due to being at a hot 190° C. temperature can be released in the absence of tension thereon by warm conditions that soften the asphalt or modified bitumen composition, which relieves the residual tension and releases the locked in thermal expansion in order to allow thermal shrinkage of the composite as a cold-applied installation on a roof undergoes diurnal warming.

In addition, relaxation and release of latent shrinkage strain can be due in part to a combination of:

(1) the glass mat in the composite to limit both stretching and shrinkage during processing;

(2) the residual or latent shrinkage tendency of the polyester component, and

(3) the freshly applied roofing material warming and exceeding a critical transition temperature allowing the polyester molecule to become unlocked for relaxation and latent shrinkage to occur. Although the thermal transition (Tg) of polyester, specifically polyethylene terephthalate), is of the order of 75° C., the β transition occurs at a considerably lower temperature. A temperature excursion exceeding this temperature may be sufficient for the thermal relaxation and latent shrinkage to occur on a warming roof.

Example 1: A composite reinforcement membrane comprises, a fiberglass mat about 34-35 g/m² combined with about 120—about 188 g/m² coated high tenacity polyester mesh and about 17 g/m² polyester nonwoven mat. After the interstices were filled with a saturant or matrix of a bituminous roofing composition and after the resultant product was cold-applied on a roofing deck, nearly instant recovery from transverse direction “ridging” was exhibited upon warming up of the installed membrane.

Construction: laminate comprising the following layers:

Layer 1: Glass mat of weight about 35 grams per square meter (g/m²).

Layer 2: Polyester mesh with the following inputs:

Machine direction yarn: 2.75 ends per centimeter of about 1440 dtex high tenacity low shrink polyester yarn or preferably ultra-low shrink polyester yarn.

Cross-machine direction yarn: 2.75 ends per centimeter of about 1440 dtex high tenacity low shrink polyester yarn or, alternatively, fiberglass yarn in cross-machine direction only.

Binder coating: cross-linked styrene butadiene rubber emulsion, preferably about 35%-75% styrene, by weight percent, and more preferably, about 45%-65% styrene, and most preferably, about 55% styrene.

Alternatively, a bituminous adhesive composition.

Combined weight of binder coated mesh components (layer 2): about 188 g/m² 1440 dtex high tenacity low shrink polyester yarn. Alternatively, fiberglass yarn in cross-machine direction only.

Layer 3: Nonwoven polyester veil of weight 17 g/m²

Combined Weight of layers 1-3: 240 grams/m²

Mechanical Properties:
MD Tensile Strength: 1400 Newtons/5 cm
MD Elongation to break: 29%
CD Tensile Strength: 1324 Newtons/5 cm
CD Elongation to break: 30%

Example 2: A second embodiment of a composite reinforcement membrane comprises, a 34 g/m² fiberglass mat combined with a 40 g/m² coated high tenacity polyester mesh, an 85 g/m² fiberglass mesh, and a 17 g/m² polyester nonwoven mat, which, after the interstices were filled with a saturant or matrix of a bituminous roofing composition, and after the result product was cold-applied on a roofing deck, the composite reinforcement membrane showed a slower, less effective correction of the “ridging” behavior typical of fiberglass reinforced membranes of a construction prior to the invention.

Example 3: the scrim or mesh comprises polyester strands in the machine direction, and inorganic strands, for example fiberglass strands, in the cross-machine direction.

Manufacture of a reinforcement by a method of three steps includes, forming a substrate in the form of a woven or laid scrim. The scrim is a mesh or grid of polyester fibers in the machine direction, and fiberglass fibers or polyester strands in the cross-machine direction. A woven scrim needs no binder. For a laid scrim, the fibers are bonded together by a binder at each of the cross-overs, where machine direction fibers extend across the fibers in the cross-machine direction. Then the scrim is bonded, by melt bonding or adhesive bonding, to a nonwoven polyester mat comprising chopped fibers about one inch in length and held by a binder. This can be done at a temperature in excess of 175° C. which substantially or essentially eliminates residual thermal shrinkage of the two polyester substrates. A glass mat of chopped fiberglass about one inch in length and held by a binder is wet or thermal laminated to the polyester substrates, with the scrim as the inner layer.

Manufacture of a reinforcement by an alternative method involves forming a laid polyester scrim while thermal hot melt bonding of the polyester fibers to one another and simultaneous thermal hot melt lamination thereof to a nonwoven polyester mat, followed by forming a fiberglass mat of chopped fiberglass about one inch in length and bonded to one another by a binder, and wherein the mat is wet laminated to the scrim by a membrane coating material.

Manufacture of a reinforcement by an alternative method involves forming a laid polyester scrim while thermal hot melt bonding of the polyester fibers to one another and simultaneous thermal hot melt lamination thereof to a nonwoven polyester mat, followed by forming a fiberglass mat of chopped fiberglass about one inch in length and bonded to one another by a binder, and wherein the polyester substrates are thermally melt bonded to the mat, with the scrim being the inner layer.

Manufacture of a reinforcement by another alternative method involves formation of a layer of a laid polyester scrim over a glass mat layer wherein the scrim is coated with an uncured binder material, a overlying the scrim with a layer formed as mat of chopped polyester fibers scrim, and curing the scrim binder material to form a lamination adhesive bonding the layers together.

This description of the exemplary embodiments is intended to be read in connection with the accompanying drawings, which are to be considered part of the entire written description. In the description, relative terms such as “lower,” “upper,” “horizontal,” “vertical,”, “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description and do not require that the apparatus be constructed or operated in a particular orientation. Terms concerning attachments, coupling and the like, such as “connected” and “interconnected,” refer to a relationship wherein structures are secured or attached to one another either directly or indirectly through intervening structures, as well as both movable or rigid attachments or relationships, unless expressly described otherwise.

Patents and patent applications referred to herein are hereby incorporated by reference in their entireties. Although the invention has been described in terms of exemplary embodiments, it is not limited thereto. Rather, the appended claims should be construed broadly, to include other variants and embodiments of the invention, which may be made by those skilled in the art without departing from the scope and range of equivalents of the invention.

What is claimed is:

1. A reinforcement membrane for reinforcing a roofing membrane, comprising:
first and second layers including a fiberglass mat and a scrim of low-shrinkage organic fibers;
a third layer comprising nonwoven low-shrinkage organic fibers, wherein the third layer covers and protects the scrim;
the third layer providing an added mass of organic fibers for possessing latent shrinkage while the reinforcement membrane is in tension, which latent shrinkage is released during a temperature increase within a range of about 10° C. to about 30° C.; and
a membrane coating material bonds together the three layers in tension, without completely filling interstices among the respective fibers of the three layers, wherein the interstices are adapted to be filled with a bituminous roofing composition.

2. The reinforcement membrane of claim 1 wherein the scrim comprises polyester fibers in the machine direction, and inorganic fibers in the cross-machine direction.

3. The reinforcement membrane of claim 1 wherein the scrim comprises polyester fibers in the machine direction, and in the cross-machine direction.

4. The reinforcement membrane of claim 1 wherein the membrane saturating material comprises rubber or a bituminous adhesive composition.

5. The reinforcement membrane of claim 1 comprising:
a fiberglass mat about 34-35 g/m²;
a coated high tenacity polyester mesh about 120-188 g/m², having high tenacity low shrink polyester yarn about 1440 dtex and a binder coating of cross-linked styrene butadiene rubber emulsion, and a combined weight of about 188 g/m² ; and
a polyester nonwoven mat of about 17 g/m².

6. The reinforcement membrane of claim 1 wherein the membrane saturant material holds the fibers in tension.

7. A method of making a reinforcement membrane for reinforcing a roofing membrane, comprising:
adding a third layer comprising nonwoven organic fibers to first and second layers including a fiberglass mat and a scrim of organic fibers, wherein the third layer covers and protects the scrim, and the third layer provides an added mass of the low-shrinkage organic fibers for possessing latent shrinkage while the reinforcement membrane is in tension, which latent shrinkage is released during a temperature increase within a range of about 10° C. to about 30° C.; and
bonding together the three layers with a membrane coating material, without completely filling interstices among the respective fibers of the three layers, wherein the interstices are adapted to be filled with a bituminous roofing composition for retaining the reinforcement membrane in tension.

8. The method of claim 7, wherein adding a third layer comprises forming a layer of a laid polyester scrim over a glass mat layer, and overlying the scrim with a layer formed mat of chopped polyester fibers scrim, and applying the membrane coating material as the scrim binder and as a lamination adhesive bonding the layers.

9. The method of claim 7, wherein adding a third layer comprises formation of a layer of a laid polyester scrim over a glass mat layer wherein the scrim is coated with an uncured binder material, overlying the scrim with a layer formed as mat of chopped polyester fibers scrim, and curing the scrim binder material to form a lamination adhesive bonding the layers together.

10. A roofing membrane, comprising:
a reinforcement membrane comprising first and second layers including a fiberglass mat and a scrim of low-shrinkage organic fibers;
a third layer comprising nonwoven low-shrinkage organic fibers, wherein the third layer covers and protects the scrim;
the third layer providing an added mass of the low-shrinkage organic fibers for possessing latent shrinkage strain while the reinforcement membrane is in tension, which latent shrinkage strain is released during a temperature increase within a range of about 10° C. to about 30° C.;
a membrane coating material bonds together the three layers, without completely filling interstices among the respective fibers of the three layers; and
a bituminous roofing composition filling the interstices and restraining the reinforcement membrane while stretched and in tension.

11. A method of making a reinforcement membrane for reinforcing a roofing membrane includes adding a third layer comprising nonwoven low-shrinkage organic fibers to first and second layers including a fiberglass mat and a scrim of low-shrinkage organic fibers, especially those fibers in the scrim extending in the machine direction, wherein the third layer covers and protects the scrim, and the third layer provides an added mass of the low-shrinkage organic fibers, for possessing latent shrinkage while the reinforcement membrane is in tension, which latent shrinkage is releasable to occur during a temperature increase within a range of about 10° C. to about 30° C., and bonding together the three layers with a membrane coating material, without completely filling interstices among the respective fibers of the three layers.

12. The method of claim 11, comprising: adding the third layer having nonwoven low-shrinkage organic fibers extending in the machine direction.

13. The method of claim 11, comprising: completely filling the interstices among the respective fibers of the three layers with a bituminous roofing composition for retaining the reinforcement membrane in tension.
